(19) United States
(12) Patent Application Publication
(10) Pub. No.: US 2024/0333821 A1
(43) Pub. Date: Oct. 3, 2024

(54) BANDWIDTH REDUCTION FOR TRANSMITTED COMPRESSED DATA

(71) Applicant: International Business Machines Corporation, Armonk, NY (US)

(72) Inventor: Lior Aronovich, Thornhill (CA)

(21) Appl. No.: 18/190,156

(22) Filed: Mar. 27, 2023

(51) Int. Cl. H04L 69/04; G06N 20/00

(52) U.S. Cl. CPC H04L 69/04; G06N 20/00; H04L 51/066

(57) ABSTRACT

Embodiments of the invention include a processor system operable to perform processor system operations that include determining, using a server of the processor system, that a set of compressed parameters of a machine learning model includes new compressed data (NCD) and previously-generated compressed data (PGCD). The NCD includes compressed data segments that were not previously transmitted to a target device of the processor system; and the PGCD includes compressed data segments that were previously transmitted to the target device of the processor system. One or more PGCD identifiers are computed based at least in part on the PGCD. The NCD and the one or more PGCD identifiers are transmitted to the target device of the processor system.

### BACKGROUND

The present invention relates in general to programmable computers. More specifically, the present invention relates to computer systems, computer-implemented methods, and computer program products operable to reduce the bandwidth required to transmit compressed data between and among distributed components of a distributed computing systems.

In federated learning and distributed learning, model parameters are iteratively sent from a server (or aggregator) to clients (or parties). Focusing on federated learning as an example, federated learning tools train a common or global machine learning (ML) model collaboratively using local models that are trained using a federated set of secure local data sources. The local data sources are never moved or combined, but instead each local model is trained, and parameters of the local model are transmitted to the central aggregation server that fuses the local model parameters to generate the common ML model. Federated learning is appropriate for situations where parties want to leverage their data without sharing their data. Each party participating in the federation uses its data to train its own local ML model, then sends the parameters of its locally trained ML model to an aggregation server, that combines or fuses the received parameters of the local ML models received from the participating parties to generate a common ML model. Parameters of the common ML model are sent back to each party and used to perform additional training, for example, in a multi-round ML process. This process is continued until the common ML model reaches a desired level of performance.

To reduce the bandwidth requirements for data transmissions in federated learning and distributed learning systems, the various model parameters can be compressed before being transmitted.

### SUMMARY

Embodiments of the invention include a processor system operable to perform processor system operations that include determining, using a server of the processor system, that a set of compressed parameters of a machine learning model includes new compressed data (NCD) and previously-generated compressed data (PGCD). The NCD includes compressed data segments that were not previously transmitted to a target device of the processor system; and the PGCD includes compressed data segments that were previously transmitted to the target device of the processor system. One or more PGCD identifiers are computed based at least in part on the PGCD. The NCD and the one or more PGCD identifiers are transmitted to the target device of the processor system.

Embodiments of the invention include a computer-implemented method and a computer program product having substantially the same features as the computer system described above.

Additional features and advantages are realized through the techniques described herein. Other embodiments and aspects are described in detail herein. For a better understanding, refer to the description and to the drawings.

### BRIEF DESCRIPTION OF THE DRAWINGS

The subject matter which is regarded as the present invention is particularly pointed out and distinctly claimed in the claims at the conclusion of the specification. The foregoing and other features and advantages are apparent from the following detailed description taken in conjunction with the accompanying drawings in which:

FIG. 1 depicts details of an exemplary computing environment operable to implement various aspects of the invention.

FIG. 2 depicts a simplified block diagram illustrating a system in accordance with embodiments of the invention;

FIG. 3 depicts a simplified block diagram illustrating additional details of how portions of the system shown in FIG. 2 can be implemented in accordance with embodiments of the invention;

FIG. 4 depicts a simplified block diagram illustrating additional details of how portions of the system shown in FIG. 2 can be implemented in accordance with embodiments of the invention;

FIG. 5 depicts a simplified block diagram illustrating additional details of how portions of the system shown in FIG. 2 can be implemented in accordance with embodiments of the invention;

FIG. 6 depicts a simplified block diagram illustrating additional details of how portions of the system shown in FIG. 2 can be implemented in accordance with embodiments of the invention;

FIG. 7 depicts a flow diagram illustrating a computer-implemented method according to embodiments of the invention;

FIG. 8 depicts a simplified block diagram illustrating a relatively large data structure operable to be compressed and transmitted in accordance with embodiments of the invention;

FIG. 9 depicts a simplified block diagram illustrating a hash function or hash algorithm operable to be used in accordance with embodiments of the invention;

FIG. 10 depicts a simplified block diagram illustrating a system in accordance with embodiments of the invention;

FIG. 11 depicts a flow diagram illustrating a computer-implemented method according to embodiments of the invention; and

FIG. 12 depicts equations associated with implementing embodiments of the invention.

In the accompanying figures and following detailed description of the disclosed embodiments, the various elements illustrated in the figures are provided with three-digit reference numbers. The leftmost digit of each reference number corresponds to the figure in which its element is first illustrated.

### DETAILED DESCRIPTION

For the sake of brevity, conventional techniques related to making and using aspects of the invention may or may not be described in detail herein. In particular, various aspects of computing systems and specific computer programs to implement the various technical features described herein are well known. Accordingly, in the interest of brevity, many conventional implementation details are only mentioned briefly herein or are omitted entirely without providing the well-known system and/or process details.

Many of the functional units of the systems described in this specification have been labeled as modules. Embodiments of the invention apply to a wide variety of module implementations. For example, a module can be implemented as a hardware circuit including custom VLSI circuits or gate arrays, off-the-shelf semiconductors such as logic chips, transistors, or other discrete components. A module can also be implemented in programmable hardware devices such as field programmable gate arrays, programmable array logic, programmable logic devices or the like. Modules can also be implemented in software for execution by various types of processors. An identified module of executable code can, for instance, include one or more physical or logical blocks of computer instructions which can, for instance, be organized as an object, procedure, or function. Nevertheless, the executables of an identified module need not be physically located together, but can include disparate instructions stored in different locations which, when joined logically together, function as the module and achieve the stated purpose for the module.

Turning now to an overview of technologies that are relevant to aspects of the invention, traditional machine learning (ML) models achieve a relatively high model accuracy by training the ML model on a large corpus of training data. In a known ML configuration, a data pipeline feeds training data to a central server that hosts and trains the model to perform tasks such as making predictions. A downside of this architecture is that all the data collected by local devices and/or sensors are sent back to the central server, which is not an option where the relevant training data must be kept confidential (e.g., personal medical records, private customer data, and the like) or where there are significant costs or other challenges for sending the training data.

Federated learning is an approach in which each device (e.g., edge computing) receives the current model and computes an updated model locally using its local data. The locally trained models are then sent from the devices back to the central server where they are aggregated (or globally trained), for example, by averaging weights, and then a single consolidated and improved global model is sent back to the devices. In a more general sense, federated learning allows ML algorithms to gain experience from a broad range of confidential data sets located at different locations or owned by different entities. The approach enables multiple organizations to collaborate on the development of models, but without needing to directly share secure data with each other. Over the course of several training iterations, the shared models are exposed to a significantly wider range of data than any single entity possesses in-house. In other words, federated learning decentralizes ML by removing the need to pool data into a single location. Instead, the model is trained in multiple iterations at different locations.

For example, multiple parties (P) (e.g., hospitals) each has its own locally resident data involving personal and/or sensitive information (e.g., electronic medical record (EMR) data), and they would like to collectively use their data to build and train a global ML model having better model performance (e.g., accuracy) than each party's local ML model alone. A third party S, denoted as an aggregator, is used to help the parties P build the global ML model by implementing a federated learning system. In an example federated learning system, each party of the parties P trains its own local ML model in a privacy-preserving way (to avoid leakage of sensitive inferences about its data) and sends parameters of its local ML model to aggregator S. Aggregator S collects the parameters of the local ML models from the parties P, uses the collected parameters to calculate the parameters for the global ML model, and sends the global ML model parameters back to the parties P for a new round of local ML model training based on the global ML model parameters. The global ML model is continuously updated in this fashion until, after several rounds, a desired model performance is reached. Aggregator S then shares the global ML model with each party of the parties P for use on each party's private and locally held data.

In federated learning and distributed learning, the transmitted model parameters can be represented by relatively large data structures such as multiple multi-dimensional arrays. Sending such large data structures repeatedly, especially over low bandwidth connections, can be prohibitive in terms of performance. This bandwidth problem is especially detrimental in federated learning settings where the clients can be mobile or otherwise edge devices, and available network bandwidth is significantly limited. For example, models that generate large updates, on the scale of gigabytes, can create a networking bottleneck that results in overall performance being significantly degraded. It is generally understood that the improvements in computation speed proceed at a faster pace than improvements in network bandwidth and/or speed capabilities. Therefore, current graphics processing units (GPUs) experience long idle times while waiting for transmitted data communication. This causes inefficient utilization of the computational resources, longer model training times, and higher computational costs.

Compression techniques have been used in an attempt to reduce the above-described bandwidth delays that result from transmitting large data structures in, for example, federated learning and distributed learning. Example compression techniques include lossy compression, which provides the benefit of enabling significant bandwidth reduction, along with the benefit of allowing the relevant models to converge despite using reconstructed/decompressed data that includes some errors. In general, model training as well as aggregating (in federated/distributed learning) are inherently statistical in nature, and therefore can converge despite the small errors introduced by the lossy compression. Although effective, known compression techniques can still result in transmitting compressed data structure that are quite large. Therefore, there exist opportunities for achieving further system performance improvements by providing techniques for further reducing the bandwidth requirements for transmitting information, particularly compressed information.

Turning now to an overview of aspects of the invention, embodiments of the invention provide computer systems, computer-implemented methods, and computer program products operable to reduce the bandwidth required for the transmission of compressed data generated in federated/distributed machine learning processes, by using knowledge from the receiving side to further reduce the size of the compressed data. Embodiments of the invention leverage the heretofore unappreciated observation that, because the products of lossy compression methods used in federated/distributed learning tend to have less variance compared with the original data structure, there is a higher probability that the receiving side has already seen a subset of the segments of elements in these products. Embodiments of the invention further leverage the heretofore unappreciated observation that, if the receiving side has already seen such a subset, there is no need to transmit this subset, and a transmission scheme can be developed that relies on only transmitting the delta subset to the receiving side. In embodiments of the invention, information that represents the compressed data segments that were already seen by the receiving side is added to existing network messages in a federated/distributed learning environment, and no additional network messages are required for this mechanism. Embodiments of the invention do not add any loss of accuracy, beyond that incurred by the lossy compression methods used in federated/distributed learning. Accordingly, embodiments of the invention add a novel lossless compression system and method on top of lossy compression, which provides significant additional compression without any accuracy compromise.

Thus, embodiments of the invention introduce to federated/distributed learning the sharing of knowledge between the server and the clients (or target devices) for compression and bandwidth reduction purposes. Embodiments of the invention also introduce to federated/distributed learning hash-based compression. These techniques, introduced into federated/distributed learning, improve compression and bandwidth reduction for the multi-dimensional arrays that are transmitted in federated/distributed learning.

Some embodiments of the invention modify the data compression operations performed by a transmitting component and a receiving component in a distributed computing system. In the transmitting component, known data compression operations (e.g., lossy compression) are modified by segmenting a pre-transmission data compression task into previously-performed data compression operations and new data compression operations. In embodiments of the invention, the previously-performed data compression operations are substantially the same as data compression operations that have been used to generate and transmit previously compressed data that was previously received and decompressed by the receiving component in the past. In embodiments of the invention, the new data compression operations are substantially not the same as data compression operations that have been used to generate and transmit previously-generated compressed data that was previously received and decompressed by the receiving component in the past. Embodiments of the invention reduce transmission bandwidth by transmitting new compressed data that results from the new data compression operations, and by not transmitting previously-generated compressed data that results from the previously-performed data compression operations. Instead of transmitting the previously-generated compressed data to the receiving component, a compressed data identifier (ID) is transmitted to the receiving component. In accordance with embodiments of the invention, the compressed data ID is configured and arranged to, in effect, point the receiving component to the results of the previously performed decompression operations and the corresponding reconstructed/decompressed data that correspond to the previously received compressed data. The receiving component thus uses the new compressed data and the compressed data IDs to reconstruct the relatively large data structures of the transmitting component, thereby avoiding the need to transmit the relatively large data structures.

Similarly, the receiving component is operable to perform the same operations in reverse where the receiving component performs the above-described operations of the transmitting component, and the transmitting component performs the above-described operations of the receiving component.

In some embodiments of the invention, the compressed data ID is a message having a data size that is significantly less than the data size of the previously generated compressed data. For example, in some embodiments of the invention, the compressed data ID can be a fixed length message of 256 bits; and the previously generated compressed data represented by the compressed data ID can be some or all of a compressed data that was generated based on an original data structure that includes multiple multidimensional arrays having a size on the scale of multiple gigabytes. In some embodiments of the invention, the compressed data ID can be a hash value generated by applying a hash algorithm to the previously-generated compressed data. In embodiments of the invention, the hash algorithm can be a secure hash algorithm (e.g. SHA-256) that generates a 256-bit (32-byte) hash value or signature from some or all of the previously generated compressed data. In some embodiments of the invention, the transmitting components and the receiving components each maintain a list of the hash values computed from some or all of each set of the previously-generated compressed data, along with the portions of each set of the previously-generated compressed data. A component that receives a compressed data ID in the form of a hash value compares the received compressed data ID or hash to the list of compressed data ID or hash to identify a match. A match means that the previously-generated local instance of compressed data corresponding to the matched compressed ID or hash can be used in the current local decompression/reconstruction operation.

In some embodiments of the invention, the distributed component system can be a federated learning system, and the distributed components can include an aggregator server in communication with one or more local client computers (or local target computers). In the federated learning system, the relatively large data structures can be the various model updates that are passed between the aggregator server and the multiple local client computers in the course of performing federated learning operations.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as a novel bandwidth reduction scheme for compressed transmitted data 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

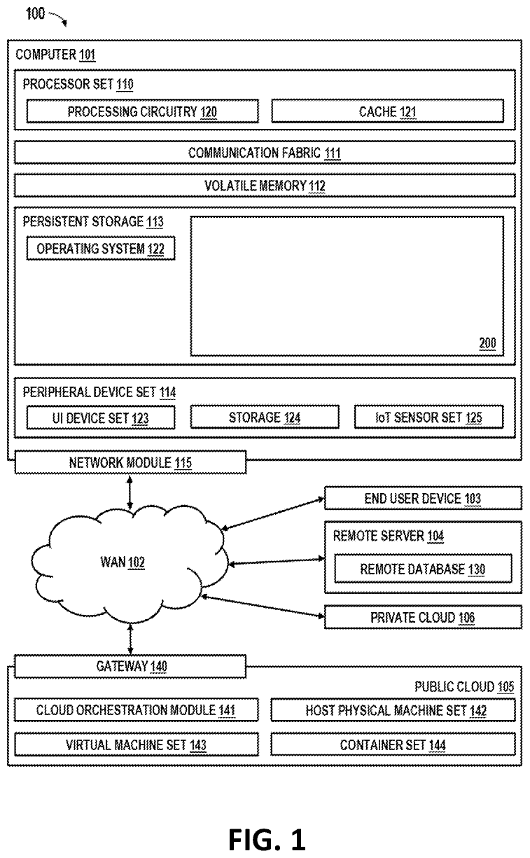

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

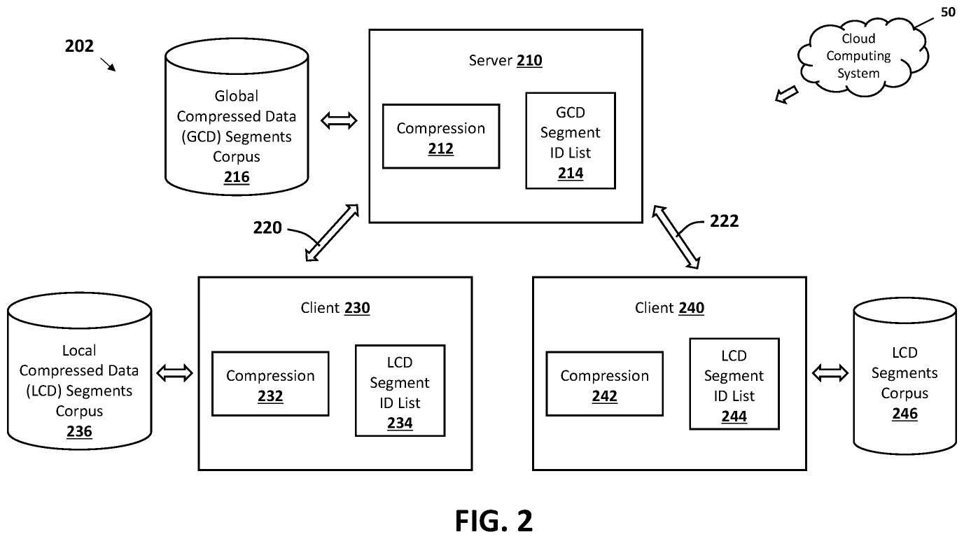

Turning now to a more detailed description of aspects of the invention, FIG. 2 depicts a simplified block diagram illustrating a distributed computing system 202 in accordance with embodiments of the invention. The distributed computing system 202 can be implemented in conjunction with any appropriate computing device and database, such as the computer system environment 100 of FIG. 1. The system 202 includes a server 210, a client (or target) 230, a client (or target) 240, a global compressed data (GCD) segments corpus 216, a local compressed data (LCD) segment corpus 236, and an LCD segments corpus 246, configured and arranged as shown. Each of the clients 230, 240 includes its own local dataset (not shown separately from the clients 230, 240). In embodiments of the invention, the server 210 includes a compression module 212 and a GCD segment identification (ID) list 214. The client 230 includes a compression module 232 and an LCD segment ID list 234. The client 240 includes a compression module 242 and an LCD segment ID list 244. Although one server 210 and two clients 230, 240 are shown in FIG. 2, the features and functionality of embodiments of the invention as described herein can be applied to any number and combination of servers and client.

A cloud computing system 50 can be in wired or wireless electronic communication with one or all of components of the system 202. Cloud computing system 50 can supplement, support, or replace some or all of the functionality of the components of the system 202. Additionally, some or all of the functionality of the components of the system 202 can be implemented as a node of the cloud computing system 50.

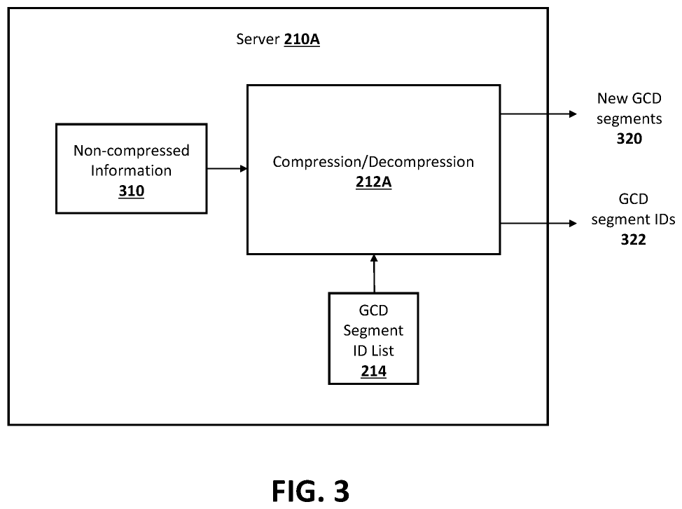

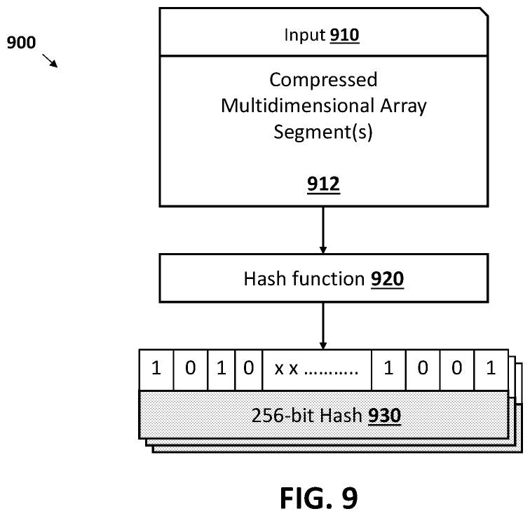

In accordance with aspects of the invention, the server 210 is operable to perform global computations and/or updates to the global computations; compress some or all of the global computations/updates (e.g., using a compression module 212); represent some of the compressed global computations/updates with low-bandwidth identifications (IDs) (e.g., GCD segment IDs 322 shown in FIG. 3; and/or hash value 930 shown in FIG. 9); and provide some of the compressed global computations/updates and the low-bandwidth IDs to the clients 230, 240 over the communications channels 220, 222. In accordance with aspects of the invention, data traffic over the transmission channels 220, 222 is significantly reduced in comparison to a scenario where all of the compressed global computations/updates are transmitted. This is because a data size of each low-bandwidth ID is significantly less that a data size of the corresponding compressed global computation/update that the low-bandwidth ID represents. A list of the low-bandwidth IDs is maintained in the GCD segment ID list 214, and corresponding local versions of the GCD segment ID list 214 are maintained at the LCD segment ID lists 234, 244. The compressed global computations/updates identified by the low-bandwidth IDs are maintained in the GCD segments corpus 216, and corresponding local versions of the GCD segments corpus 216 are maintained at the LCD segments corpus 236 and the LCD segments corpus 246.

Each of the clients 230, 240 is operable to receive the compressed global computations/updates and the low-bandwidth IDs transmitted from the server 210 to the clients 230, 240 over the communications channels 220, 222. Using client 230 as an example, in accordance with aspects of the invention, the client 230 uses the received low-bandwidth ID to identify and access from the LCD segments corpus 236 a local version of the compressed global computation/update identified by the received low-bandwidth ID. The compressed global computations/updates received over the communications channel 220, along with the local version of the compressed global computation/update accessed from the LCD segments corpus 236, are decompressed by the compression module 232 to reconstruct the global computations/updates generated by the server 210. Substantially the same operations are performed by the client 240 on the compressed global computations/updates and the low-bandwidth IDs transmitted from the server 210 to the client 240 over the communications channel 222.

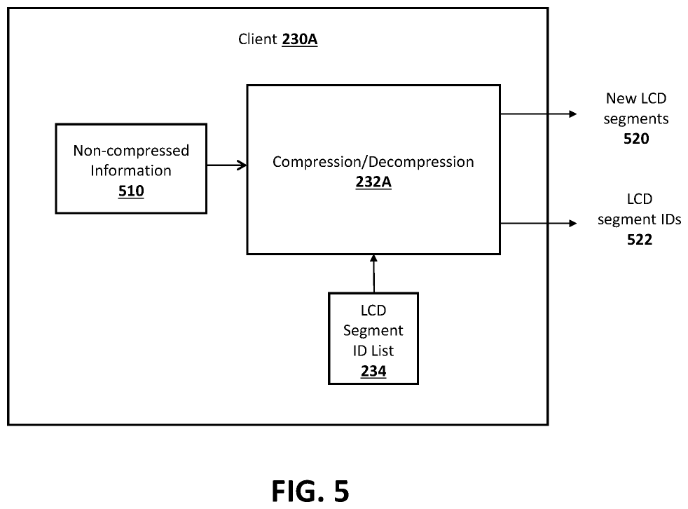

In embodiments of the invention, substantially the same operations described above in connection with transmissions from the server 210 are performed in reverse where the client 230 is operable to perform local computations and/or updates to the local computations; compress some or all of the local computations/updates (e.g., using a compression module 232); represent some of the compressed local computations/updates with low-bandwidth identifications (IDs) (e.g., LCD segment IDs 522 shown in FIG. 5; and/or hash value 930 shown in FIG. 9); and provide some of the compressed local computations/updates and the low-bandwidth IDs to the server 210 over the communications channels 220. Client 240 is operable to perform substantially the same operations described in this paragraph as being performed by the client 230.

The block diagram of the system 202 shown in FIG. 2 is simplified in that it is not intended to indicate that the system 202 is to include all of the components shown. Instead, the system 202 can include any appropriate fewer or additional components not illustrated in FIG. 2 (e.g., servers, local datasets, additional memory components, embedded controllers, functional blocks, connections between functional blocks, modules, inputs, outputs, etc.). Further, the embodiments of the invention described herein with respect to the system 202 can be implemented with any appropriate logic, wherein the logic, as referred to herein, can include any suitable hardware (e.g., a processor, an embedded controller, or an application specific integrated circuit, among others), software (e.g., an application, among others), firmware, or any suitable combination of hardware, software, and firmware, in various embodiments.

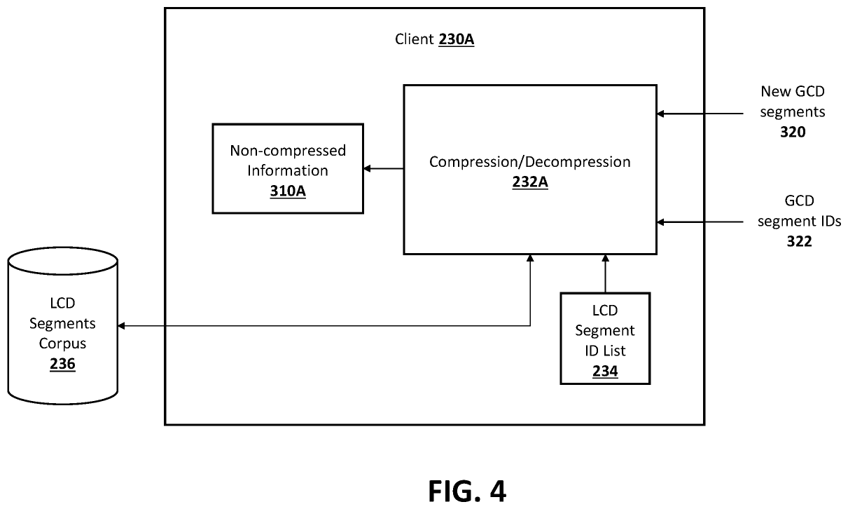

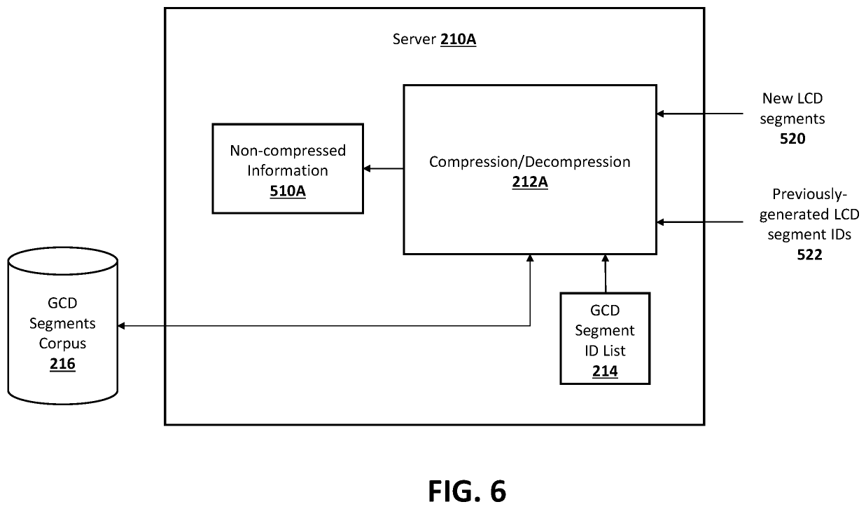

FIG. 3 depicts a server 210A functioning as a transmitting component of the system 202, and FIG. 4 depicts a client 230A functioning as a receiving component of the system 202, both in accordance with embodiments of the invention. Similarly, FIG. 5 depicts the client 230A functioning as a transmitting component of the system 202, and FIG. 6 depicts the server 210A functioning as a receiving component of the system 202, both in accordance with embodiments of the invention. The server 210A shown in FIGS. 3 and 6 is substantially the same as the server 210 (shown in FIG. 2) but provides additional details about how the compression module 212 (shown in FIG. 2) can be implemented as a compression/decompression module 212A operable to perform compression operations on to-be-transmitted data (e.g., non-compressed information 310 shown in FIG. 3) to generate new GCD segments 320 and GCD segment IDs 322 (shown in FIG. 3), as well as perform decompression/restructuring operations on received data (e.g., new LCD segments 520 and LCD segment IDs 522 shown in FIG. 6) to generate non-compressed information 510A (shown in FIG. 6), which is a reconstruction/decompression of the non-compressed information 510 (shown in FIG. 5). The client 230A shown in FIGS. 4 and 5 is substantially the same as the client 230 (shown in FIG. 2) but provides additional details about how the compression module 232 (shown in FIG. 2) can be implemented as a compression/decompression module 232A operable to perform compression operations on to-be-transmitted data (e.g., non-compressed information 510 shown in FIG. 5) to generate new LCD segments 520 and LCD segment IDs 522 (shown in FIG. 5), as well as perform decompression/restructuring operations on received data (e.g., new GCD segments 320 and GCD segment IDs 322 shown in FIG. 4) to generate non-compressed information 310A (shown in FIG. 4), which is a reconstruction/decompression of the non-compressed information 310 (shown in FIG. 3).

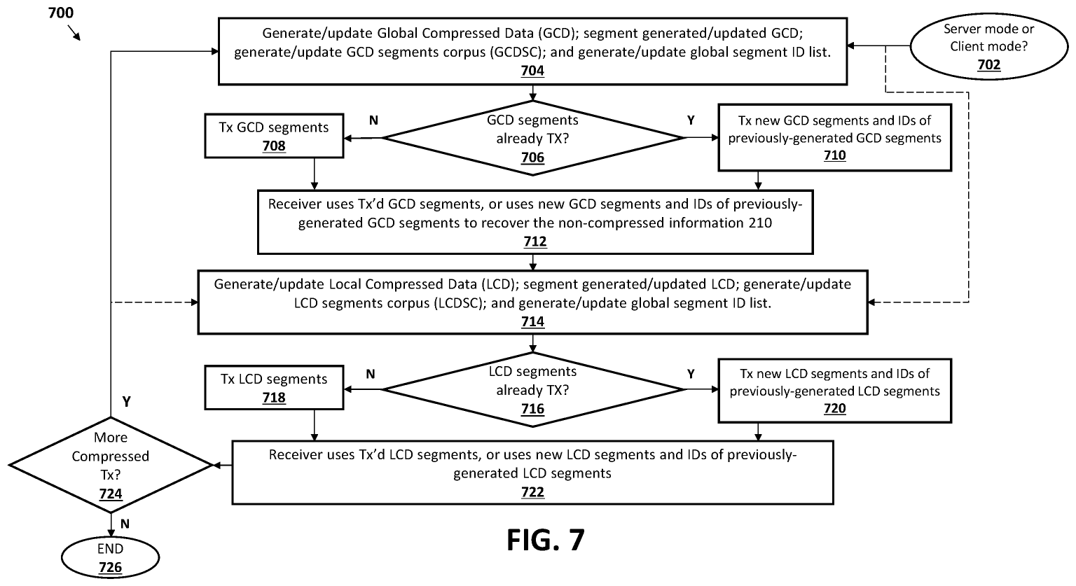

In accordance with aspects of the invention, the compression/decompression module 212A depicted in FIG. 3 is operable to perform compression operations (e.g., lossy compression) on the non-compressed information 310 in a manner that takes into account decompression operations that have already been performed by the server 210, 210A and/or the clients 230, 230A, 240. More specifically, instead of transmitting compressed data that is substantially the same as previously transmitted compressed data, previously transmitted compressed data is associated with a low-bandwidth ID (e.g., GCD segment IDs 322 shown in FIG. 3; and/or hash value 930 shown in FIG. 9); the low-bandwidth ID is transmitted to the clients 230, 240; and each client 230, 240 uses the low-bandwidth ID to access a local version of the previously transmitted compressed data that is associated with the low-bandwidth ID. In aspects of the invention, the clients 230, 230A, 240 also compress and transmit data to the server 210, 210A using substantially the same transmission process described above for the server 210, 210A. In accordance with embodiments of the invention, the client 240 can be implemented to include substantially the same components and perform substantially the same operations as the client 230, 230A. The operations of the system 202, along with the operations of the client 230A, will be describe subsequently herein in connection with the description of the computer-implemented methodology 700 shown in FIG. 7.

FIG. 7 depicts a flow diagram illustrating a computer-implemented methodology 700 that is implemented by the system 202 (shown in FIG. 2), as well as the implementation examples shown in FIG. 3-6 in accordance with embodiments of the invention. The description of the methodology 700 will make reference to the operations defined at the various blocks of the methodology 700, as well as the corresponding components of the system 202, the server 210A (shown in FIGS. 3 and 6), and the client 230A (shown in FIGS. 4 and 5). Turning now to the specific details of the methodology 700, as shown in FIG. 7, block 702 initiates the methodology 700 by selecting either the server 210, 210A (i.e., the server start mode) or the client 230, 230A, 240 (i.e., the client start mode) as the starting point for the system 202. When the system 202 begins in the client start mode, the clients 230, 230A, 240 perform their local operations first at blocks 714-722, and subsequently the methodology 700 moves to blocks 704-712 where the server 210, 210A performs global operations based on data/information received from the clients 230, 230A, 240. When the system 202 begins in the server start mode, the server 210, 210A performs its global operations first at blocks 704-712, and subsequently the methodology 700 moves to blocks 714-722 where the clients 230, 230A, 240 perform their local operations based on data/information received from the server 210, 210A. For ease of explanation, it will be assumed that the initial selection at block 702 is the server start mode.

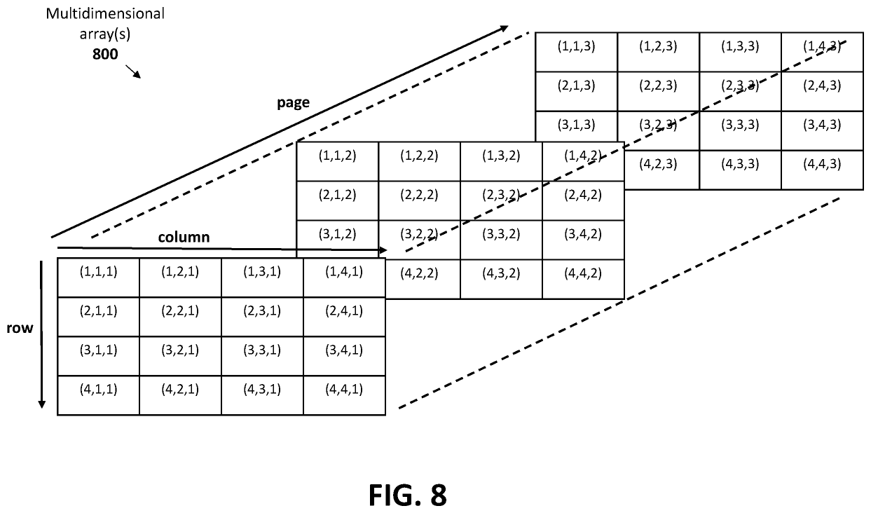

The methodology 700 starts at block 702 by selecting the server start mode and moves to block 704 where the server 210, 210A accesses global non-compressed information 310 and provides it to the compression/decompression module 312A. In accordance with aspects of the invention, the non-compressed information 310 can be a relatively large (e.g . . . , multiple gigabytes) data structure. A non-limiting example of the relatively large data structure is multiple instances of the multidimensional array 800 (shown in FIG. 8) having rows, columns, and pages extending in three dimensions. In accordance with aspects of the invention, the compression/decompression module 212A is operable to perform compression and/or decompression operations; and, for the operations depicted at block 704, the compression/decompression module 212A performs compression operations.

Continuing with the operations at block 704, in some embodiments of the invention, the non-compressed information 310 is compressed and segmented (in any order) to form global compressed data (GCD) segments. Alternatively, in some embodiments of the invention, the non-compressed information 310 can be first compressed and then segmented to form global compressed data (GCD) segments. The GCD segments are evaluated to determine the new GCD segments 320 (shown in FIG. 3) and the previously-generated GCD segments that are associated with previously-performed compression operations and have been previously transmitted to one or more of the clients 230, 230A, 240. The GCD segments corpus 216 is updated to include the new GCD segments 320 and any of the previously-generated GCD segments that are not already stored in the GCD segments corpus 216. In accordance with aspects of the invention, a low-bandwidth ID was determined as a GCD segment ID and associated with the previously-generated GCD segment in the GCD segments corpus 216 when the previously-generated GCD segment was stored in the GCD segments corpus 216. In accordance with aspects of the invention, a low-bandwidth ID is determined as a GCD segment ID and associated with new GCD segments 320 in the GCD segments corpus 216 when the new GCD segments 320 are stored in the GCD segments corpus 216.

Each GCD segment ID is stored in the GCD segment ID list 214. In some embodiments of the invention, each GCD segment ID in the GCD segment ID list 214 can be implemented as a hash value computed from the GCD segment ID's corresponding new or previously-generated GCD segment. For example, as depicted in FIG. 9, where the GCD segments are compressed multidimensional arrays segments 912 generated, for example, from the multidimensional arrays 800 (shown in FIG. 8), a hash function 920 can be applied to a segment of the compressed multidimensional array segments 912 to generate a unique fixed length (e.g., 256-bit) hash value for each new or previously-generated GCD segment stored in the GCD segments corpus 216. In accordance with embodiments of the invention, the hash value 920 is unique to a given segment of the compressed multidimensional array segments 912 such that if a first hash value is identical to a second hash value, it can be concluded that the two GCD segments from which the matching hash values were computed are also identical.

Subsequent to block 704, the methodology 700 moves to decision block 706 to determine whether GCD segments generated at block 704 are previously-generated GCD segments that have already been transmitted (Tx). If the answer to the inquiry at decision block 706 is no, all of the GCD segments are new GCD segments 320, and the methodology 700 moves to block 708 and transmits the new GCD segments 320 over the communications channels 220, 222 to the client 230, 230A and/or the client 240. If the answer to the inquiry at decision block 706 is yes, some of the GCD segments are new GCD segments 320, and some of the GCD segments are previously-generated GCD segments having GCD segment IDs 322 associated therewith. Accordingly, where the answer to the inquiry at decision block 706 is yes, the methodology 700 moves to block 710 and transmits the new GCD segments 320 and the GCD segment IDs 322 (associated with the previously-generated GCD segments) over the communications channels 220, 222 to the client 230, 230A and/or the client 240.

Subsequent to the operations at block 708 or block 710, the methodology 700 moves to block 712 where the receiver (e.g., the client 230, 230A and/or the client 240) receives and processes the transmissions received over the communications channels 220, 222. Where the methodology 700 arrives at block 712 from block 708, only new GCD segments 320 are received at the compression/decompression module 232A of the client 230A where the new GCD segments 320 are decompressed to generate non-compressed information 310A, which is a decompression/reconstruction of the non-compressed information 310 of the server 210A. Where the methodology 700 arrives at block 712 from block 710, both the new GCD segments 320 and the GCD segment IDs 322 (associated with the previously-generated GCD segments) are received at the compression/decompression module 232A of the client 230A. The compression/decompression module 232A replaces GCD segment IDs 322 with their corresponding segments of compressed data. This can be accomplished by using the GCD segment IDs 322 to determine whether there is a match in the LCD segment ID list 234. If there is a match between the GCD segment IDs 322 and the LCD segment ID list 234, the matching LCD segment IDs can be used to point to the corresponding local instance(s) of the LCD segments in the LCD segments corpus 236, and the corresponding local instance(s) of the LCD segments in the LCD segments corpus 236 are decompressed/reconstructed by the compression/decompression 232A. Subsequently, all of the segments (those used directly and those retrieved via their GCD segment IDs) are put together to form a compressed data set so that the compressed data set in full is decompressed or reconstructed into non-compressed data. This is done so that the compression mechanism of the compression/decompression module 232A sees the full compressed data set for decompression.

Blocks 714-722 represent the portion of the methodology 700 where the client 230, 230A and/or the client 240 function as the transmitter, and the server 210, 210A functions as the receiver. At block 714, the client 230, 230A accesses local non-compressed information 510 and provides it to the compression/decompression module 232A. In accordance with aspects of the invention, the non-compressed information 510 can be a relatively large (e.g., multiple gigabytes) data structure. A non-limiting example of the relatively large data structure is multiple instances of the multidimensional array 800 (shown in FIG. 8) having rows, columns, and pages extending in three dimensions. In accordance with aspects of the invention, the compression/decompression module 232A is operable to perform compression and/or decompression operations; and, for the operations depicted at block 714, the compression/decompression module 232A performs compression operations.

Continuing with the operations at block 714, in some embodiments of the invention, the non-compressed information 510 is compressed and segmented (in any order) to form local compressed data (LCD) segments. Alternatively, in some embodiments of the invention, the non-compressed information 510 can be first compressed and then segmented to form local compressed data (LCD) segments. The LCD segments are evaluated to determine the new LCD segments 520 (shown in FIG. 5) and the previously-generated LCD segments that are associated with previously-performed compression operations and have been previously transmitted to the server 210, 210A. The LCD segments corpus 236 is updated to include the new LCD segments 320 and any of the previously-generated LCD segments that are not already stored in the LCD segments corpus 236. In accordance with aspects of the invention, a low-bandwidth ID was determined as an LCD segment ID and associated with the previously-generated LCD segment in the LCD segments corpus 236 when the previously-generated LCD segment was stored in the LCD segments corpus 236. In accordance with aspects of the invention, a low-bandwidth ID is determined as an LCD segment ID and associated with new LCD segments 520 in the GCD segments corpus 216 when the new GCD segments 320 are stored in the GCD segments corpus 216.

Each LCD segment ID is stored in the LCD segment ID list 234. In some embodiments of the invention, each LCD segment ID in the LCD segment ID list 234 can be implemented as a hash value computed from the LCD segment ID's corresponding new or previously-generated LCD segment. For example, as depicted in FIG. 9, where the LCD segments are compressed multidimensional arrays segments 912 generated, for example, from the multidimensional arrays 800 (shown in FIG. 8), a hash function 920 can be applied to a segment of the compressed multidimensional array segments 912 to generate a unique fixed length (e.g., 256-bit) hash value 930 for each new or previously-generated LCD segment stored in the LCD segments corpus 236. In accordance with embodiments of the invention, the hash value 930 is unique to a given segment of the compressed multidimensional array segments 912 such that if a first hash value is identical to a second hash value, it can be concluded that the two LCD segments from which the matching hash values were computed are also identical.

Subsequent to block 714, the methodology 700 moves to decision block 716 to determine whether LCD segments generated at block 714 are previously-generated LCD segments that have already been transmitted (Tx)). If the answer to the inquiry at decision block 716 is no, all of the LCD segments are new LCD segments 520, and the methodology 700 moves to block 718 and transmits the new LCD segments 520 over the communications channels 220, 222 to the server 210, 210A. If the answer to the inquiry at decision block 716 is yes, some of the LCD segments are new LCD segments 520, and some of the LCD segments are previously-generated LCD segments having LCD segment IDs 522 associated therewith. Accordingly, where the answer to the inquiry at decision block 716 is yes, the methodology 700 moves to block 720 and transmits the new LCD segments 520 and the LCD segment IDs 522 (associated with the previously-generated LCD segments) over the communications channels 220, 222 to the server 210, 210A.

Subsequent to the operations at block 718 or block 720, the methodology 700 moves to block 722 where the receiver (e.g., the server 210, 210A) receives and processes the transmissions received over the communications channels 220, 222. Where the methodology 700 arrives at block 722 from block 718, only new LCD segments 520 are received at the compression/decompression module 212A of the server 210, 210A where the new LCD segments 520 are decompressed to generate non-compressed information 510A, which is a decompression/reconstruction of the non-compressed information 510 of either or both of the clients 230, 230A, 240. Where the methodology 700 arrives at block 722 from block 720, both the new LCD segments 520 and the LCD segment IDs 522 (associated with the previously-generated LCD segments) are received at the compression/decompression module 212A of the server 210A. The compression/decompression module 212A replaces LCD segment IDs 522 with their corresponding segments of compressed data. This can be accomplished by using the LCD segment IDs 522 to determine whether there is a match in the GCD segment ID list 214. If there is a match between the LCD segment IDs 522 and the GCD segment ID list 214, the matching GCD segment IDs can be used to point to the corresponding local instance(s) of the GCD segments in the GCD segments corpus 216, and the corresponding local instance(s) of the GCD segments in the GCD segments corpus 216 are decompressed/reconstructed by the compression/decompression 212A. Subsequently, all of the segments (those used directly and those retrieved via their LCD segment IDs) are put together to form a compressed data set so that the compressed data set in full is decompressed or reconstructed into non-compressed data. This is done so that the compression mechanism of the compression/decompression module 212A sees the full compressed data set for decompression.

Subsequent to block 722, the methodology 700 moves to decision block 724 to determine whether there is more compressed data to transmit in either direction over the communications channels 220, 222. If the answer to the inquiry at decision block 724 is no, the methodology 700 moves to block 726 and ends. If the answer to the inquiry at decision block 724 is yes, the methodology 700 moves to either block 714 to perform another iteration of blocks 714-722, or to block 704 to perform another iteration of blocks 704-722. In some embodiments of the invention, additional iterations of blocks 714-722 can be performed based on a determination at decision block 724 that one or more of the clients (e.g., client 240) have not transmitted compressed data to the server 210, 210A.

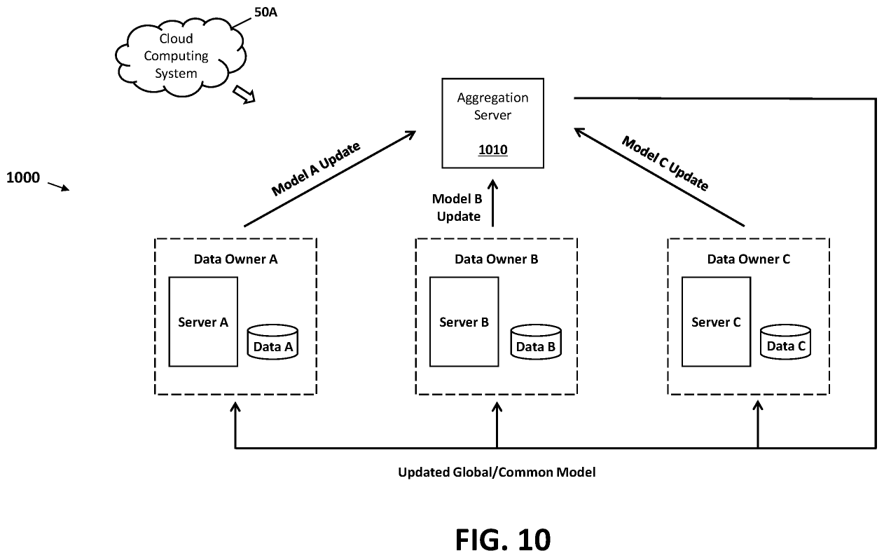

FIG. 10 depicts a simplified block diagram illustrating a distributed computing system implemented as a federated learning system 1000 in accordance with embodiments of the invention. The federated learning system 1000 can be implemented in conjunction with any appropriate computing device and database, such as the computer system environment 100 of FIG. 1. As depicted in FIG. 10, the federated learning system 1000 includes an aggregation server 1010 communicatively coupled to servers and data repositories for various data owners. Data Owner A maintains Server A and Data A (or data repository A); Data Owner B maintains Server B and Data B (or data repository B); and Data Owner C maintains Server C and Data C (or data repository C). In some embodiments of the invention, the Data Owners A-C are entities that operate in the same general field (e.g., hospital healthcare) but are each a separate entity at a separate physical location. For example, Data Owner A can be a general acute care hospital in a suburb of City A; Data Owner B can be a long-term care hospital within the city limits of City A; and Data Owner C can be a government hospital (e.g., a Veteran's Health Administration (VHA) hospital) within the city limits of City A. Each of the Servers A-C can include sub-components such as multiple individual processors, processor systems, or servers, all in communication with one another at their particular location (e.g., the sub-components of Server A are at Data Owner A's physical location).

The federated learning system 1000 can implement any type of federated learning. In general, federated learning is a process of computing a common or global ML model by using input from several locally resident ML models that have been trained using private and locally held data. In some embodiments of the invention, the federated learning process implemented by the federated learning system 1000 includes the aggregation server 1010 generating an initial version of a global or common ML model and broadcasting it to each of the Servers A-C. Each of the Servers A-C, includes training data and test data. Each of the Servers A-C uses its local data to train its own local ML model in a privacy-preserving way (to avoid leakage of sensitive inferences about its data) and sends parameters of its local ML model to the aggregation server 1010, which collects the parameters of the various ML models from the Servers A-C, uses them to calculate updated parameters for the global ML model, and sends the global ML model parameters back to the Servers A-C for a new round of local ML model training based on the global ML model parameters. After several rounds of continuously updating the global ML model in this fashion, a desired model performance level is reached. The aggregation server 1010 then shares this global ML model with each of the Servers A-C for (future) use on each of the Server's private and locally held data.

A cloud computing system 50A can be in wired or wireless electronic communication with one or all of components of the federated learning system 1000. Cloud computing system 50A can supplement, support, or replace some or all of the functionality of the components of the federated learning system 1000. Additionally, some or all of the functionality of the components of the federated learning system 1000 can be implemented as a node of the cloud computing system 50A.

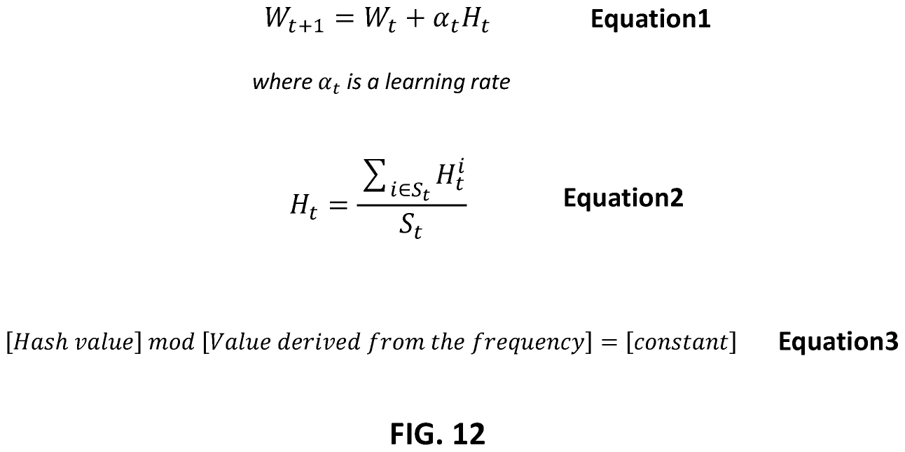

The goal of the federated learning system 1000 is to learn a model with parameters embodied in a real multi-dimensional array W∈R^{d1×2} from data stored across a large number of clients (e.g., Data Owners A-C). In a training round t≥0, the server 1010 distributes the current model Wₜ (Updated Global/Common Model) to a subset St of the n clients. These clients independently update the model based on their local data. If the updated local models are Wₜ¹, Wₜ², . . . , Wₜ^{S}^{ₜ}, the update of client i can be written as Hₜⁱ=Wₜⁱ−Wₜ. These updates are the result of a calculation done by each client based on the client's local dataset. Each of these clients then sends Hₜⁱ to the sever 1010, where the global update is computed by aggregating all the clients' updates using an aggregation algorithm, for example, Equation1 and Equation2 shown in FIG. 12.

Embodiments of the invention are operable to reduce the network bandwidth required for sending the multi-dimensional arrays Hₜⁱ from the clients (e.g., Data Owners A-C) to the sever 1010; and sending the multi-dimensional array Wₜ from the server 1010 to the clients (e.g., Data Owners A-C). Without loss of generality, the following examples use Hₜⁱ, and the same processes can be applied to Wₜ. The compression process applied on Hₜⁱ creates a compression product Cₜⁱ (that typically includes multiple sub-products), where the storage required for Cₜⁱ is smaller than the storage required for Hₜⁱ, and Cₜⁱ is transmitted to the server 1010 instead of Hₜⁱ. For lossless compression, Hₜⁱ is reconstructed from Cₜⁱ by the server 1010. For lossy compression, which has advantages for federated learning (i.e., lossy compressions of machine learning model parameters can produce a smaller data structure relative to lossless compression and enables convergence despite data errors in the lossy compression), an approximation multi-dimensional array [symbol] is reconstructed from Cₜⁱ by the server 1010, where Hₜⁱ≈ [symbol] . In these methods, Cₜⁱ is composed of a set of multi-dimensional arrays, whose combined size is smaller than the size of Hₜⁱ.

The server 1010 keeps a data structure of representations of model segments that were already seen in model updates sent from the clients (e.g., Data Owners A-C) previously. The clients keep a data structure of representations of model segments that the server 1010 sends as well as that the client has already processed in the current model update. In some embodiments of the invention, the representations can be cryptographic hash values (e.g., hash value 930) of each of these segments, e.g. SHA-256. The representations can be computed for any multi-dimensional array (e.g., multidimensional array 800 shown in FIG. 8) that is to be sent on the network (e.g., communications channels 220, 222 shown in FIG. 2). For example, the multi-dimensional arrays that compose a compressed model update Cₜⁱ. The data structures would typically be or include the hash tables 1010, 1030 (shown in FIG. 10). For a side that only encodes, the data structure can store only the hash values. Example implementation can be a memory size bound set. For a side that decodes and potentially also encodes, the data structure must store the hash values along with references to (or the actual) associated model segments. Example implementation can be a memory size bound map or a dictionary.

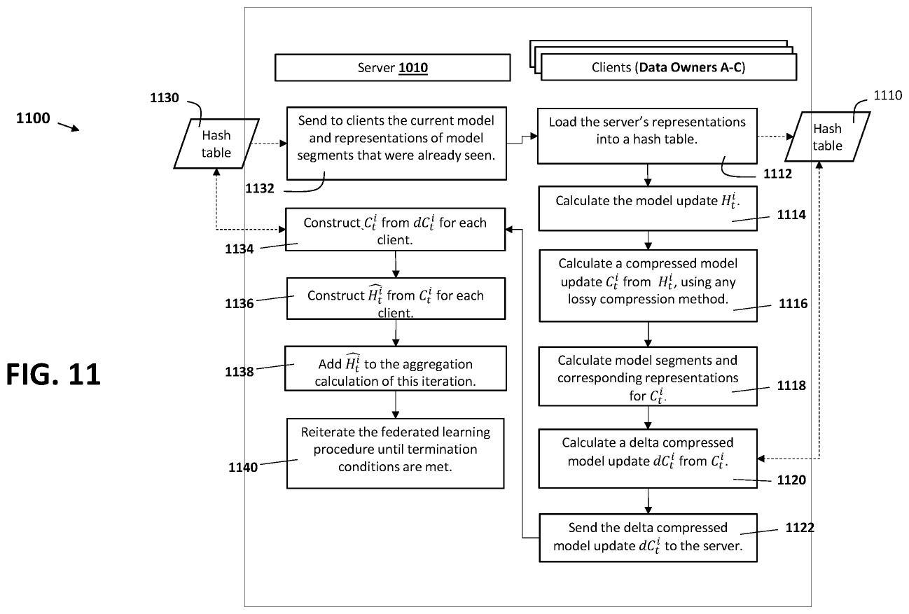

FIG. 11 depicts a computer-implemented methodology 1100 operable to be performed by the federated learning system 1000 (shown in FIG. 10). The methodology 1100 includes operations at blocks 1112-1122 performed at each of the clients servers (e.g., Data Owners A-C), along with operations at blocks 1132-1140 performed at the server 1010. At block 1132, when the server 1010 sends the current model Wₜ to the clients (Data Owners A-C), it also adds the representations of the model segments it has already seen, where the representations are from its hash table 1130 (shown in FIG. 11). The server 1010 can send either all the representations, or a subset of the representations with the highest probability of being reused, e.g. using LRU (least recently used) statistics. Sending all the representations in the server's search structure has a size overhead for the network message and is less efficient. Therefore, the server uses the following proposed method to select an efficient subset of the representations for sending to a given party so that the representations in the subset have a high probability of being utilized by the given party. The server maintains data structures that enable to rank representations based on the frequency of their usage and recency of their usage by the parties. These data structures are termed “global ranking data structures.” If the number of parties is not large (this is a frequent use case), the server further maintains such data structures per party, that enable to rank representations based on the access performed by each individual party. These data structures are termed “party specific ranking data structures.” Retention of representations in the server's search data structure is done based on the global ranking data structures, to retain those representations that have the highest utility globally. A procedure for selecting representations to send for a given party includes making an assumption that that the number of representations that can be sent from the server to a party has an upper bound B; if there are party specific ranking data structures associated with the given party, then the server selects the top B ranked representations from these data structures, where P is the number of representations selected in this step; and if B−P is positive, then select the top ranked B−P representations from the global ranking data structures.

At block 1112, for each client (e.g., Data Owners A-C), the client loads the server's representations into a hash table 1110. At block 1114, the model update Hₜⁱ is computed. At block 1116, a compressed model update Cₜⁱ is calculated from Hₜⁱ, using any lossy compression method. At block 1118, model segments and corresponding representations for Cₜⁱ are computed. A method for computing segments and segment boundaries for Cₜⁱ is specified subsequently below. Block 1120 computes a delta compressed model update dCₜⁱ from Cₜⁱ as follows. For each representation from Cₜⁱ that is found in the client's hash table, if the representation came from the server 1010, then the client embeds the representation instead of the actual model segment in dCₜⁱ, and adds the index where the representation is embedded into a list of indexes which is part of dCₜⁱ. If the representation came from previously processed model segments of Cₜⁱ (and not from the server 1010), then the client embeds a back reference to the first occurrence of that model segment instead of the actual model segment in dCₜⁱ, and adds the index where the back reference is embedded into a list of back references which is part of dCₜⁱ. The client can maintain a single hash table 1110 that supports an origin indication per representation, or maintain two hash tables 1110, 1130—one for representations coming from the server and a second one for representations coming from the client. For each representation from Cₜⁱ that is not found in the client's hash table 1110, the client keeps the original model segment in dCₜⁱ, and adds this representation to the hash table 1110. It is also optional to add the representation to a list of model segment representations that is part of dCₜⁱ, so that the representation references its associated model segment. This enables avoiding re-calculation on the server side of the representations for model segments that the server 1010 has not yet seen. Because the representations are smaller compared with their corresponding model segments (described in greater detail below), this enables dCₜⁱ to be smaller compared with Cₜⁱ, resulting in significant bandwidth savings. At block 1122 the client sends the delta compressed model update dCₜⁱ to the server 1010.

Turning now to operations at the server 1010, at block 1134 the methodology 1100 constructs Cₜⁱ from dCₜⁱ for each client as follows. For each representation embedded in dCₜⁱ, find its corresponding model segment in the hash table 1130 and replace it with its corresponding model segment in the Cₜⁱ being constructed. Use the list of indexes in dCₜⁱ for this processing. For each back reference embedded in dCₜⁱ, replace it with its corresponding model segment found backwards in the Cₜⁱ being constructed. The methodology 1100 uses the list of back references in dCₜⁱ for this processing. For each model segment in the Cₜⁱ being constructed, if its representation is not found in the hash table 1130, add this representation, along with a reference to its corresponding model segment, to the hash table 1130. If the representation for the model segment is included in dCₜⁱ, it is used, otherwise it is computed. At block 1136, the methodology 1100 constructs [symbol] from Cₜⁱ for each client. The operations at block 1136 can be performed using a method that depends on the type of compression method that was used to generate Cₜⁱ from Hₜⁱ. At block 1138, the methodology 1100 adds [symbol] to the aggregation computation of this iteration. At block 1140, the methodology 1100 reiterates the federated learning procedure until termination conditions are met.

A methodology for computing model segments and corresponding representations will now be provided. Both the model update Hₜⁱ and the compressed model update Cₜⁱ typically each contain multiple multi-dimensional arrays of values. The total size of Cₜⁱ is smaller than the total size of Hₜⁱ. To calculate model segments for Cₜⁱ in a way that is repeatable and robust to changes in the multi-dimensional arrays, embodiments of the invention utilize the methodology described below. It is noted that repeatability and robustness are important because hash values change for any change in the underlying data, and it is desirable that changes in the underlying data will affect only their local segments and not affect any other segments. The proposed method is also independent of the dimensionality and shapes of the multi-dimensional arrays in Cₜⁱ. The proposed methodology proceeds as follows. For each multi-dimensional array in Cₜⁱ, convert the multi-dimensional array to a flat array in a repeatable way. Access the byte representation of the flat array. Find repeatable segmentation locations in the byte representation of the flat array, using one of the following methods-variable size segmentation; and fixed size segmentation.

For variable size segmentation, this method should be used for cases where the shapes of the multi-dimensional arrays in Cₜⁱ may change. This methodology defines an expected frequency for finding a segmentation location. This frequency is fixed once defined. The expected frequency is expressed as “find a segmentation location on average every N bytes”. The methodology calculates an array of rolling hash values on the byte representation of the flat array. The methodology scans the rolling hash values by applying a condition to each rolling hash value, where the condition is based on the frequency defined above. An example of a simple condition is Equation3 (shown in FIG. 12). For every rolling hash value that satisfies the condition-its position is determined as a segmentation location.

For fixed size segmentation, this methodology can be used for cases where the shapes of the multi-dimensional arrays in Cₜⁱ do not change. The methodology defines a segment size. This size is fixed once defined. The methodology splits the byte representation of the flat array to fixed size segments from its beginning, according to the defined segment size.

Both of the methodologies specified above apply a lower bound on the segment size, wherein the segment size should be larger than the size of the cryptographic hash value and location index that both represent the segment in dCₜⁱ. For example, the size of the SHA256 hash is 32 bytes, and the size of a location index can be 4 bytes. Accordingly, this segment size must be larger than 36 bytes. For each segment determined in the previous step, a cryptographic hash value is computed, for example SHA256. It is possible to concatenate multiple multi-dimensional arrays from Cₜⁱ into a unified flat array, and apply the above method to the unified flat array. However, because this may join values of different domains, in embodiments of the invention, the flat arrays are kept separate.

A methodology for storing representations in the server 1010 proceeds as follows. The hash table storing the representations should be preserved between iterations. Namely, it will keep representations across iterations. The hash table should include representations coming from all the relevant clients. This enables cross-client compression scope. The hash table should be of a fixed/controlled size, by using a retention and purge policy. This should be applied also to the clients' hash tables.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” are understood to include any integer number greater than or equal to one, i.e. one, two, three, four, etc. The terms “a plurality” are understood to include any integer number greater than or equal to two, i.e. two, three, four, five, etc. The term “connection” can include both an indirect “connection” and a direct “connection.”

Additionally, the terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

Additionally, the terms “compressed data segment” and equivalents thereof are used herein to refer to a data segment that has been reduced in size by a computing device executing a conventional data compression algorithm. Compressed data segments can be smaller in size (e.g., Bytes) than their respective source data segments. For example, a compressed data segment can be 64 Bytes whereas its corresponding source (i.e., uncompressed) data segment can be 256 Bytes.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

The various components, modules, sub-function, and the like of the systems illustrated herein are depicted separately for ease of illustration and explanation. In embodiments of the invention, the operations performed by the various components, modules, sub-functions, and the like can be distributed differently than shown without departing from the scope of the various embodiments of the invention described herein unless it is specifically stated otherwise.

For convenience, some of the technical operations described herein are conveyed using informal expressions. For example, a processor that has key data stored in its cache memory can be described as the processor “knowing” the key data. Similarly, a user sending a load-data command to a processor can be described as the user “telling” the processor to load data. It is understood that any such informal expressions in this detailed description should be read to cover, and a person skilled in the relevant art would understand such informal expressions to cover, the informal expression's corresponding more formal and technical description.

1. A computer system comprising a processor system communicatively coupled to memory, wherein the processor system is operable to perform processor system operations comprising:
determining, using a server of the processor system, that a set of compressed parameters of a machine learning (ML) model comprises new compressed data (NCD) and previously-generated compressed data (PGCD);
wherein the NCD comprises compressed data segments that were not previously transmitted to a target device of the processor system;
wherein the PGCD comprises compressed data segments that were previously transmitted to the target device of the processor system;
computing one or more PGCD identifiers based at least in part on the PGCD; and
transmitting the NCD and the one or more PGCD identifiers to the target device of the processor system;
wherein a data size of the one or more PGCD identifiers is less than a data size of the PGCD;
wherein each of the one or more PGCD identifiers transmitted to the target device of the processor system comprises a hash value; and
wherein the target device of the processor system is operable to determine a local version of the PGCD based at least in part on the one or more PGCD identifiers.

2. (canceled)

3. (canceled)

4. (canceled)

5. The computer system of claim 14, wherein the target device of the processor system is operable to use the local version the PGCD and the NCD to generate a local version of the set of compressed parameters of the ML model.

6. The computer system of claim 5, wherein the target device of the processor system is further operable to decompress the local version of the set of compressed parameters of the ML model to generate reconstructed parameters of the ML model.

7. The computer system of claim 6, wherein the target device of the processor system is further operable to:
use the reconstructed parameters of the ML model to update a local instance of the ML model; and
use local data of the target device of the processor system to further train the updated local instance of the ML model.

8. A computer-implemented method comprising:
determining, using a server of a processor system, that a set of compressed parameters of a machine learning (ML) model comprises new compressed data (NCD) and previously-generated compressed data (PGCD);
wherein the NCD comprises compressed data segments that were not previously transmitted to a target device of the processor system;
wherein the PGCD comprises compressed data segments that were previously transmitted to the target device of the processor system;
computing one or more PGCD identifiers based at least in part on the PGCD; and
transmitting the NCD and the one or more PGCD identifiers to the target device of the processor system.

9. The computer-implemented method of claim 8, wherein a data size of the one or more PGCD identifiers is less than a data size of the PGCD.

10. The computer-implemented method of claim 8, wherein each of the one or more PGCD identifiers transmitted to the target device of the processor system comprises a hash value.

11. The computer-implemented method of claim 8, wherein the target device of the processor system is operable to determine a local version of the PGCD based at least in part on the one or more PGCD identifiers.

12. The computer-implemented method of claim 11, wherein the target device of the processor system is operable to use the local version the PGCD and the NCD to generate a local version of the set of compressed parameters of the ML model.

13. The computer-implemented method of claim 12, wherein the target device of the processor system is further operable to decompress the local version of the set of compressed parameters of the ML model to generate reconstructed parameters of the ML model.

14. The computer-implemented method of claim 13, wherein the target device of the processor system is further operable to:
use the reconstructed parameters of the ML model to update a local instance of the ML model; and
use local data of the target device of the processor system to further train the updated local instance of the ML model.

15. A computer program product comprising a computer readable program stored on a computer readable storage medium, wherein the computer readable program, when executed on a processor system, causes the processor system to perform processor system operations comprising:
determining, using a server of the processor system, that a set of compressed parameters of a machine learning (ML) model comprises new compressed data (NCD) and previously-generated compressed data (PGCD);
wherein the NCD comprises compressed data segments that were not previously transmitted to a target device of the processor system;
wherein the PGCD comprises compressed data segments that were previously transmitted to the target device of the processor system;
computing one or more PGCD identifiers based at least in part on the PGCD; and
transmitting the NCD and the one or more PGCD identifiers to the target device of the processor system.

16. The computer program product of claim 15, wherein a data size of the one or more PGCD identifiers is less than a data size of the PGCD.

17. The computer program product of claim 15, wherein each of the one or more PGCD identifiers transmitted to the target device of the processor system comprises a hash value.

18. The computer program product of claim 15, wherein the target device of the processor system is operable to determine a local version of the PGCD based at least in part on the one or more PGCD identifiers.

19. The computer program product of claim 18, wherein the target device of the processor system is operable to use the local version the PGCD and the NCD to generate a local version of the set of compressed parameters of the ML model.

20. The computer program product of claim 19, wherein the target device of the processor system is further operable to:
decompress the local version of the set of compressed parameters of the ML model to generate reconstructed parameters of the ML model;
use the reconstructed parameters of the ML model to update a local instance of the ML model; and
use local data of the target device of the processor system to further train the updated local instance of the ML model.
